(19) United States
(12) Patent Application Publication
(10) Pub. No.: US 2025/0238032 A1
(43) Pub. Date: Jul. 24, 2025

(54) UNMANNED AERIAL VEHICLE CONTROL METHOD BASED ON HEADLESS MODE AND REMOTE CONTROLLER AND RELATED AIRCRAFT ASSEMBLY

(71) Applicant: QISDA CORPORATION, Taoyuan City (TW)

(72) Inventors: Chih-Ming Chang, Taoyuan City (TW); Po-Fu Wu, Taoyuan City (TW)

(73) Assignee: QISDA CORPORATION, Taoyuan City (TW)

(21) Appl. No.: 19/008,660

(22) Filed: Jan. 3, 2025

(30) Foreign Application Priority Data
Jan. 18, 2024 (CN) 202410076975.6

(51) Int. Cl. G05D 1/49; G05D 1/85; G05D 109/20

(52) U.S. Cl. CPC G05D 1/49; G05D 1/85; B64U 2201/20; G05D 2109/20

(57) ABSTRACT

An unmanned aerial vehicle (UAV) control method is based on a headless mode and applied to a remote controller and a related aircraft assembly. The UAV control method includes receiving a first orientation datum generated by a drone, acquiring a second orientation datum relevant to the remote controller and provided by an electronic compass, acquiring an operation angle datum generated by a joystick of the remote controller, and computing a difference between the first orientation datum and a sum of the second orientation datum and the operation angle datum for setting as fly angle information of the drone.

### BACKGROUND OF THE INVENTION

### 1. Field of the Invention

The present invention relates to an unmanned aerial vehicle control method and a related remote controller and a related aircraft assembly, and more particularly, to an unmanned aerial vehicle control method based on a headless mode and a related remote controller and a related aircraft assembly.

### 2. Description of the Prior Art

The drone can fly to any position in the three-dimensional space; if the drone is far away from the user and the remote controller, the user cannot visually decide the nose azimuth of the drone, and it is difficult to control the drone moved back to the user, so that the drone is switched into a headless mode for recall. The conventional drone in the headless mode does not detect the nose azimuth of the drone; instead, the conventional drone acquires the fly direction of the drone, and receives the joystick operation direction of the remote controller for analysis by the drone. The analysis result controls the wings of the drone, so that the fly direction of the drone is the same as the direction of the joystick operation direction. However, when the conventional drone is in the headless mode, and the remote controller and the user who holds the remote controller cannot change the position or the steering direction, otherwise the drone receives the wrong joystick operation direction, and the fly direction computed and executed in the situation is different from the joystick operation direction. Therefore, design of an unmanned aerial vehicle control method based on the headless mode and with preferred convenient operation is an important issue in the drone industry.

### SUMMARY OF THE INVENTION

The present invention provides an unmanned aerial vehicle control method based on a headless mode and a related remote controller and a related aircraft assembly for solving above drawbacks.

According to the claimed invention, an unmanned aerial vehicle control method with a headless mode includes receiving a first orientation datum generated by a drone, acquiring a second orientation datum relevant to a remote controller and provided by an electronic compass, acquiring an operation angle datum generated by a joystick of the remote controller, and computing a difference between the first orientation datum and a sum of the second orientation datum and the operation angle datum for setting as fly angle information of the drone.

According to the claimed invention, the unmanned aerial vehicle control method is applied to the remote controller having the electronic compass, and adapted to control a movement of the drone in the same direction as the operation angle datum.

According to the claimed invention, the unmanned aerial vehicle control method further includes utilizing a wireless transmission module of the remote controller to transmit the fly angle information to the drone.

According to the claimed invention, the first orientation datum is an absolute coordinate orientation of the drone, and the second orientation datum is an absolute coordinate orientation of the remote controller.

According to the claimed invention, the unmanned aerial vehicle control method determines a nose azimuth of the drone by the first orientation datum, and computes a difference between the first orientation datum and the second orientation datum, so as to calibrate the operation angle datum via the difference for acquiring the fly angle information.

According to the claimed invention, a remote controller of controlling a movement of a drone includes a wireless transmission module, an electronic compass, a joystick and an operation processor. The wireless transmission module is adapted to receive a first orientation datum generated by a drone. The electronic compass is adapted to provide a second orientation datum of the remote controller. The joystick is adapted to generate an operation angle datum according to a user's gesture. The operation processor is electrically connected to the wireless transmission module, the electronic compass and the joystick. The operation processor is adapted to compute a difference between the first orientation datum and a sum of the second orientation datum and the operation angle datum for setting as fly angle information of the drone, so as to control the movement of the drone in the same direction as the operation angle datum.

According to the claimed invention, an aircraft assembly includes a drone and a remote controller. The drone is adapted to provide and transmit a first orientation datum. The remote controller of controlling a movement of the drone includes a wireless transmission module, an electronic compass, a joystick and an operation processor. The wireless transmission module is adapted to receive a first orientation datum generated by a drone. The electronic compass is adapted to provide a second orientation datum of the remote controller. The joystick is adapted to generate an operation angle datum according to a user's gesture. The operation processor is electrically connected to the wireless transmission module, the electronic compass and the joystick. The operation processor is adapted to compute a difference between the first orientation datum and a sum of the second orientation datum and the operation angle datum for setting as fly angle information of the drone, so as to control the movement of the drone in the same direction as the operation angle datum.

The drone can fly to any position in the three-dimensional space; if the drone is far away from the user and the remote controller, the user cannot visually decide the nose azimuth of the drone, and it is difficult to control the drone moved back to the user. Therefore, the unmanned aerial vehicle control method and the remote controller and the aircraft assembly of the present invention can switch the drone into the headless mode; at this time, the fly direction of the drone can be based on the orientation of the user and the remote controller. The remote controller of the present invention can analyze the first orientation datum of the drone, the second orientation datum of the remote controller, and the operation angle datum of the joystick to compute the fly angle information, and transmit the fly angle information to the drone for direction control, so that the drone can be easily guided back to the user.

The unmanned aerial vehicle control method and the remote controller and the aircraft assembly of the present invention can acquire the nose azimuth of the drone, and the remote controller can execute the unmanned aerial vehicle control method to transmit the computed fly angle information to the drone. The unmanned aerial vehicle control method of the present invention can set the azimuth of the remote controller as a variable factor to compute the fly angle information, so that the user who holds the remote controller can freely change the position and the steering direction, which has an advantage of easy operation without complicated learning, and can improve market competition of the aircraft assembly and the unmanned aerial vehicle control method of the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an aircraft assembly according to an embodiment of the present invention.

FIG. 2 is a diagram of a drone according to the embodiment of the present invention.

FIG. 3 is a diagram of a remote controller according to the embodiment of the present invention.

FIG. 4 is a diagram of an absolute coordinate system applied to the aircraft assembly according to the embodiment of the present invention.

FIG. 5 is a diagram of the drone 12 and the remote controller in the first example according to the embodiment of the present invention.

FIG. 6 is a diagram of the drone 12 and the remote controller in the fifth example according to the embodiment of the present invention.

FIG. 7 is a flow chart of an unmanned aerial vehicle control method according to the embodiment of the present invention.

### DETAILED DESCRIPTION

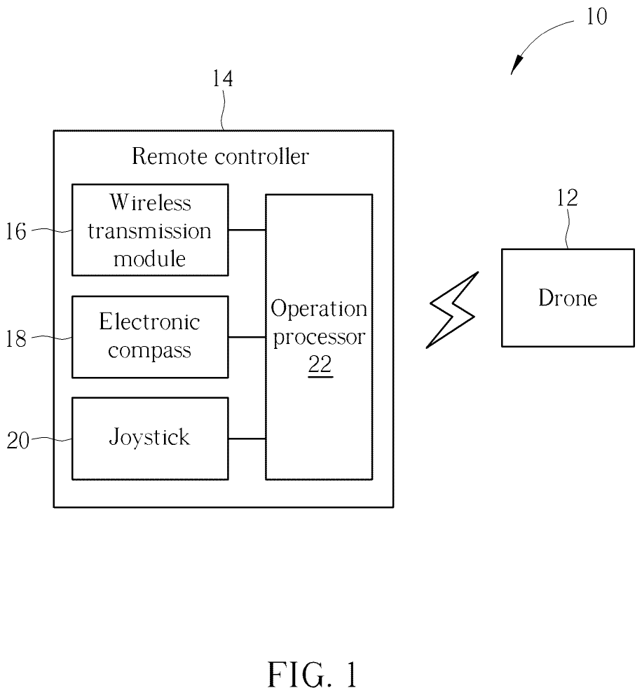

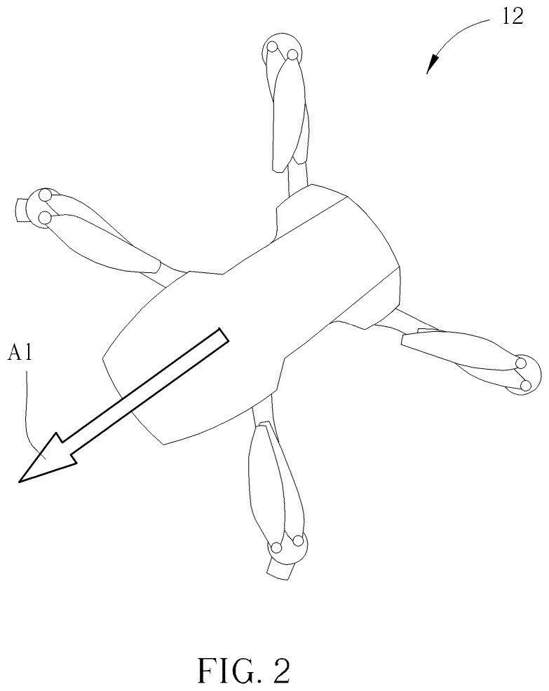

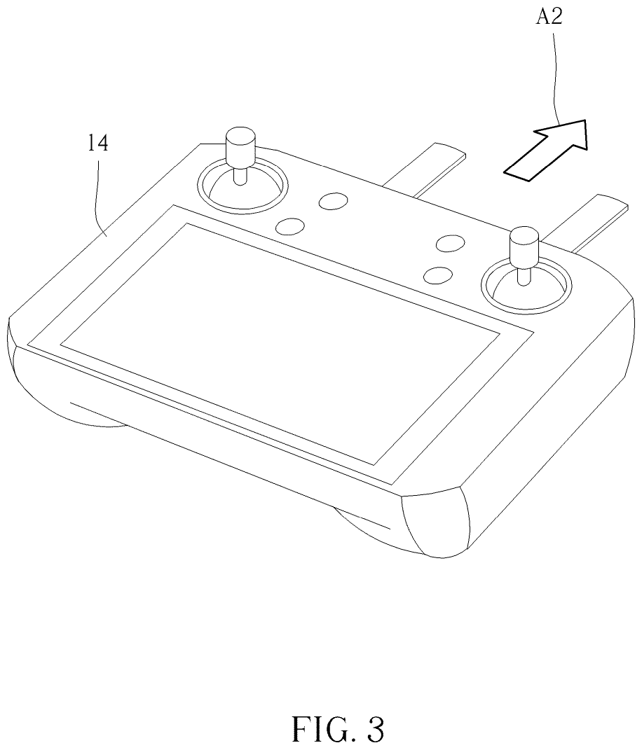

Please refer to FIG. 1 to FIG. 3. FIG. 1 is a functional block diagram of an aircraft assembly 10 according to an embodiment of the present invention. FIG. 2 is a diagram of a drone 12 according to the embodiment of the present invention. FIG. 3 is a diagram of a remote controller 14 according to the embodiment of the present invention. The aircraft assembly 10 can include the drone 12 and the remote controller 14. The drone 12 can be a rotor type multi-axis drone, and can be changed in accordance with an actual demand. The remote controller 14 can output an operation command to control a movement of the drone 12. In the preferred embodiment of the present invention, the drone 12 can be the rotor type drone; the remote controller 14 may have two joysticks. The left-side joystick can control ascending motion, descending motion, left rotation and right rotation of the drone 12, and the right-side joystick can control forward motion, backward motion, left shifting motion and right shifting motion of the drone 12; practical application of the joysticks is not limited to the foresaid embodiment.

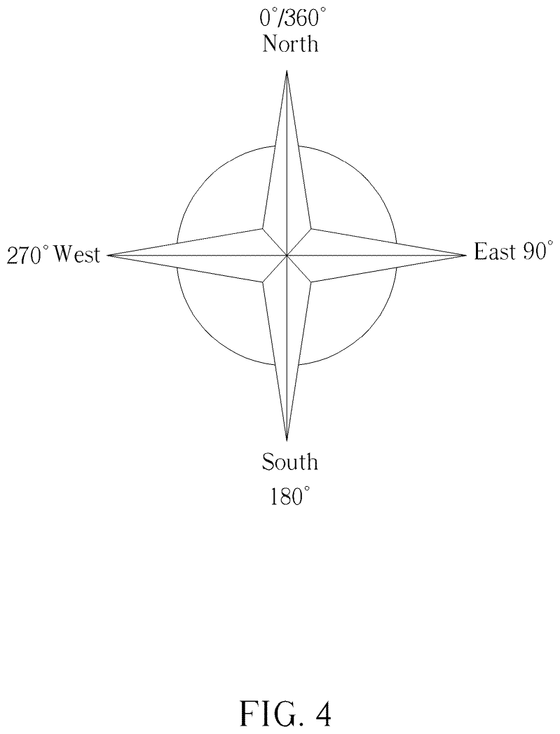

The remote controller 14 can include a wireless transmission module 16, an electronic compass 18, a joystick 20 and an operation processor 22. The wireless transmission module 16 can receive a first orientation datum A1 provided by and transmitted from the drone 12; in the embodiment, the first orientation datum A1 can be represented as a nose azimuth of the drone 12. The electronic compass 18 can provide a second orientation datum A2 of the remote controller 14, which means a forward azimuth of the remote controller 14. Please refer to FIG. 4. FIG. 4 is a diagram of an absolute coordinate system applied to the aircraft assembly 10 according to the embodiment of the present invention. The first orientation datum A1 and the second orientation datum A2 can respectively be absolute coordinate orientation of the drone 12 and the remote controller 14. Angle values of each orientation can be shown in FIG. 4, and a detailed description of relation between the azimuth and the angle values is omitted herein for simplicity.

The remote controller 14 can further include a display screen, an operation button, a universal serial bus connector, a power storage component, and other applicable electronic components. The foresaid electronic components can be electrically connected to the operation processor for related application programs, and are not shown in the figures for simplicity.

The joystick 20 can be the left-side joystick or the right-side joystick of the remote controller 14, and can generate an operation angle datum A3 in accordance with a user's gesture. Relation between the operation angle datum A3 and the absolute coordinate orientation can refer to the embodiment shown in FIG. 4. The operation processor 22 can be electrically connected to the wireless transmission module 16, the electronic compass 18 and the joystick 20. The operation processor 22 can compute a difference between the first orientation datum A1 and a sum of the second orientation datum A2 and the operation angle datum A3, and define the difference as the fly angle information A4 of the drone 12. The fly angle information A4 can be transmitted to the drone 12 via the wireless transmission module 16, so as to control the movement of the drone 12 in the same direction as the operation angle datum A3. Please refer to Table 1.

TABLE 1

| Example | A2 | A1 | A3 | A4 |
|---|---|---|---|---|
| No. 1 | 360° | 0° | Top (0°) | 0°/360° |
| No. 2 | 360° | 90° | Top (0°) | 270° |
| No. 3 | 360° | 180° | Top (0°) | 180° |
| No. 4 | 360° | 270° | Top (0°) | 90° |
| No. 5 | 360° | 45° | Top (0°) | 315° |
| No. 6 | 360° | 135° | Top (0°) | 225° |
| No. 7 | 360° | 225° | Top (0°) | 135° |
| No. 7 | 360° | 315° | Top (0°) | 45° |

For instance, the first orientation datum A1 of the first example can be zero degree, and the nose azimuth of the drone 12 can point towards the north, the second orientation datum A2 provided by the electronic compass 18 can be 360 degrees and the remote controller 14 can point towards the north, as shown in FIG. 4; in the meantime, if the joystick 20 is pulled upwardly to the north, the operation angle datum A3 can be interpreted as zero degree, and therefore the operation processor 22 can compute the sum of the second orientation datum A2 and the operation angle datum A3 being 360 degrees, and then compute the difference between the sum and the first orientation datum A1 being 360 degrees, so the remote controller 14 can transmit the fly angle information A4 (which can be zero degree or 360 degrees) to the drone 12 via the wireless transmission module 16, and the movement of the drone 12 can be in the same direction (towards the north) as the operation angle datum A3.

Further, referring to the angle values of the first example, the operation processor 22 can acquire the first orientation datum A1 to decide the nose azimuth (which equals zero degree or 360 degrees to point towards the north) of the drone 12, and compute the difference between the first orientation datum A1 and the second orientation datum A2 that can be 360 degrees, and then compute the sum of the difference and the operation angle datum A3 for calibration, and the sum that is equal to 360 degrees can be used as the fly angle information A4. Therefore, the remote controller 14 can transmit the fly angle information A4 (which can be zero degree or 360 degrees) to the drone 12 via the wireless transmission module 16, and the movement of the drone 12 can be in the same direction (towards the north) as the operation angle datum A3.

In the fifth example, the first orientation datum A1 received by the remote controller 14 and provided by the drone 12 can be forty-five degrees, the second orientation datum A2 provided by the electronic compass 18 can be 360 degrees; in the meantime, if the joystick 20 is pulled upwardly to the north, the operation angle datum A3 can be interpreted as zero degree, and the operation processor 22 can compute the sum of the second orientation datum A2 and the operation angle datum A3 being 360 degrees, and then compute the difference between the sum and the first orientation datum A1 being 315 degrees, so that the remote controller 14 can transmit the fly angle information A4 (which can be 315 degrees) to the drone 12 via the wireless transmission module 16, and the movement of the drone 12 can be in the same direction (towards the north) as the operation angle datum A3.

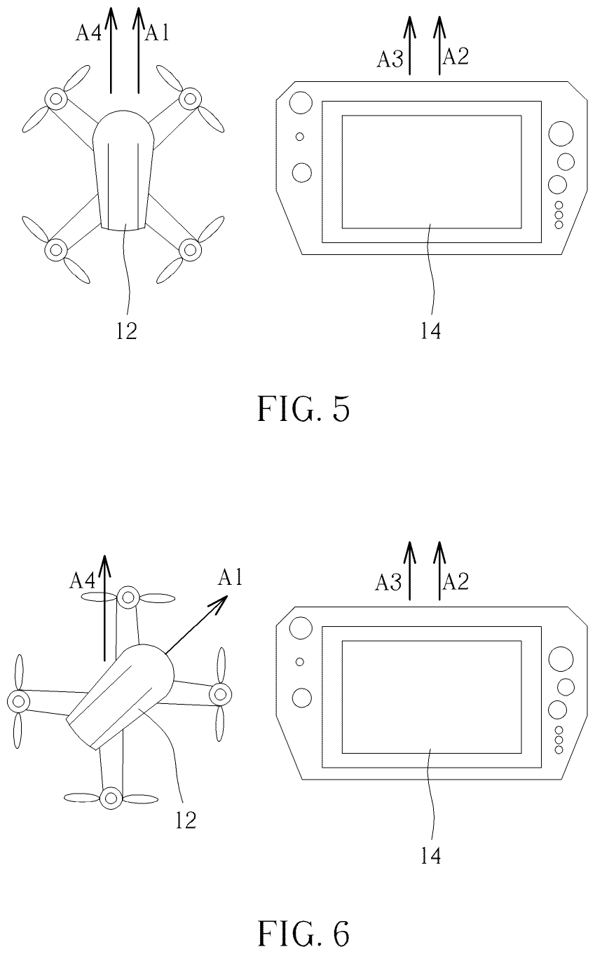

Please refer to FIG. 5 and FIG. 6. FIG. 5 is a diagram of the drone 12 and the remote controller 14 in the first example according to the embodiment of the present invention. FIG. 6 is a diagram of the drone 12 and the remote controller 14 in the fifth example according to the embodiment of the present invention. Other examples in Table 1 can be computed in accordance with the first example and the fifth example, and are not shown in the figures for simplicity. Values of the first orientation datum A1, the second orientation datum A2 and the operation angle datum A3 are not limited to the foresaid embodiment, and can be changed in accordance with the actual demand for acquiring the fly angle information A4.

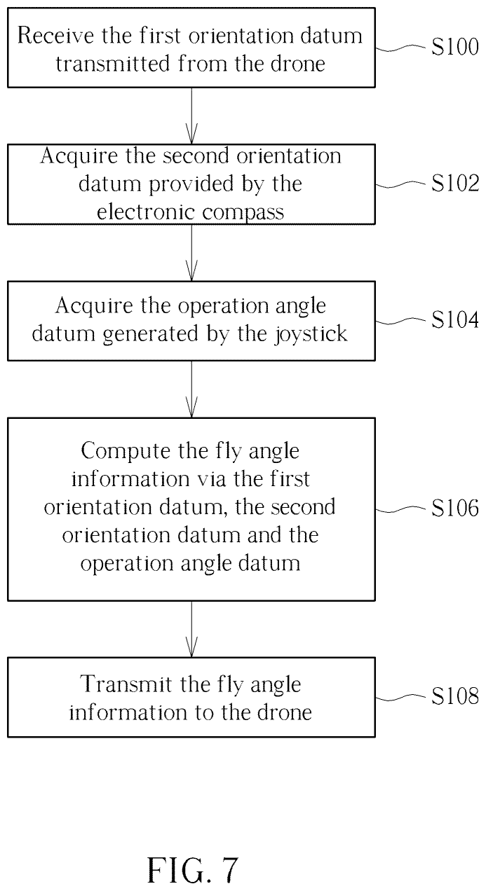

Please refer to FIG. 7. FIG. 7 is a flow chart of an unmanned aerial vehicle control method according to the embodiment of the present invention. The unmanned aerial vehicle control method illustrated in FIG. 7 can be suitable for the drone 12 and the remote controller 14 of the aircraft assembly 10 shown in FIG. 7. The unmanned aerial vehicle control method can be preferably applied for the remote controller 14 having the electronic compass 18, and can acquire the second orientation datum A2 of the remote controller 14 for calibration, so as to control the movement of the drone 12 in the same direction as the operation angle datum A4 generated by the joystick 20 of the remote controller 14.

According to the unmanned aerial vehicle control method, step S100 and step S102 can be executed to receive the first orientation datum A1 transmitted from the drone 12, and acquire the second orientation datum A2 provided by the electronic compass 18. An order of step S100 and step S102 can be executed in reverse. Then, step S104 can be executed to acquire the operation angle datum A3 generated by the joystick 20. The nose azimuth of the drone 12 and orientation of the user who holds the remote controller 14 may be changed in many ways in accordance with the actual demand. For ensuring that the movement of the drone 12 in a headless mode can be in the same direction as the operation angle datum A3, step S106 and step S108 can be executed to compute the fly angle information A4 via the first orientation datum A1, the second orientation datum A2 and the operation angle datum A3, and transmit the fly angle information A4 to the drone 12, thereby achieving the design purpose of the present invention.

In conclusion, the drone can fly to any position in the three-dimensional space; if the drone is far away from the user and the remote controller, the user cannot visually decide the nose azimuth of the drone, and it is difficult to control the drone moved back to the user. Therefore, the unmanned aerial vehicle control method and the remote controller and the aircraft assembly of the present invention can switch the drone into the headless mode; at this time, the fly direction of the drone can be based on the orientation of the user and the remote controller. The remote controller of the present invention can analyze the first orientation datum of the drone, the second orientation datum of the remote controller, and the operation angle datum of the joystick to compute the fly angle information, and transmit the fly angle information to the drone for direction control, so that the drone can be easily guided back to the user.

Comparing to the prior art, the unmanned aerial vehicle control method and the remote controller and the aircraft assembly of the present invention can acquire the nose azimuth of the drone, and the remote controller can execute the unmanned aerial vehicle control method to transmit the computed fly angle information to the drone. The unmanned aerial vehicle control method of the present invention can set the azimuth of the remote controller as a variable factor to compute the fly angle information, so that the user who holds the remote controller can freely change the position and the steering direction, which has an advantage of easy operation without complicated learning, and can improve market competition of the aircraft assembly and the unmanned aerial vehicle control method of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An unmanned aerial vehicle control method with a headless mode, the unmanned aerial vehicle control method comprising:
receiving a first orientation datum generated by a drone;
acquiring a second orientation datum relevant to a remote controller and provided by an electronic compass;
acquiring an operation angle datum generated by a joystick of the remote controller; and
computing a difference between the first orientation datum and a sum of the second orientation datum and the operation angle datum for setting as fly angle information of the drone.

2. The unmanned aerial vehicle control method of claim 1, wherein the unmanned aerial vehicle control method is applied to the remote controller having the electronic compass, and adapted to control a movement of the drone in the same direction as the operation angle datum.

3. The unmanned aerial vehicle control method of claim 1, further comprising:
utilizing a wireless transmission module of the remote controller to transmit the fly angle information to the drone.

4. The unmanned aerial vehicle control method of claim 1, wherein the first orientation datum is an absolute coordinate orientation of the drone, and the second orientation datum is an absolute coordinate orientation of the remote controller.

5. The unmanned aerial vehicle control method of claim 1, wherein the unmanned aerial vehicle control method determines a nose azimuth of the drone by the first orientation datum, and computes a difference between the first orientation datum and the second orientation datum, so as to calibrate the operation angle datum via the difference for acquiring the fly angle information.

6. A remote controller of controlling a movement of a drone, the remote controller comprising:
a wireless transmission module adapted to receive a first orientation datum generated by a drone;
an electronic compass adapted to provide a second orientation datum of the remote controller;
a joystick adapted to generate an operation angle datum according to a user's gesture; and
an operation processor electrically connected to the wireless transmission module, the electronic compass and the joystick, the operation processor being adapted to compute a difference between the first orientation datum and a sum of the second orientation datum and the operation angle datum for setting as fly angle information of the drone, so as to control the movement of the drone in the same direction as the operation angle datum.

7. The remote controller of claim 6, wherein the operation processor utilizes the wireless transmission module to transmit the fly angle information to the drone.

8. The remote controller of claim 6, wherein the first orientation datum is an absolute coordinate orientation of the drone, and the second orientation datum is an absolute coordinate orientation of the remote controller.

9. The remote controller of claim 6, wherein the operation processor determines a nose azimuth of the drone by the first orientation datum, and computes a difference between the first orientation datum and the second orientation datum, so as to calibrate the operation angle datum via the difference for acquiring the fly angle information.

10. An aircraft assembly comprising:
a drone adapted to provide and transmit a first orientation datum; and
a remote controller of controlling a movement of the drone, the remote controller comprising:
a wireless transmission module adapted to receive the first orientation datum;
an electronic compass adapted to provide a second orientation datum of the remote controller;
a joystick adapted to generate an operation angle datum according to a user's gesture; and
an operation processor electrically connected to the wireless transmission module, the electronic compass and the joystick, the operation processor being adapted to compute a difference between the first orientation datum and a sum of the second orientation datum and the operation angle datum for setting as fly angle information of the drone, so as to control the movement of the drone in the same direction as the operation angle datum.

11. The aircraft assembly of claim 10, wherein the operation processor utilizes the wireless transmission module to transmit the fly angle information to the drone.

12. The aircraft assembly of claim 10, wherein the first orientation datum is an absolute coordinate orientation of the drone, and the second orientation datum is an absolute coordinate orientation of the remote controller.

13. The aircraft assembly of claim 10, wherein the operation processor determines a nose azimuth of the drone by the first orientation datum, and computes a difference between the first orientation datum and the second orientation datum, so as to calibrate the operation angle datum via the difference for acquiring the fly angle information.
